(19) United States
(12) Patent Application Publication
(10) Pub. No.: US 2007/0284796 A1
(43) Pub. Date: Dec. 13, 2007

(54) Clamping mechanism

(76) Inventor: Richard M. Hummel, Parma, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/448,643

(22) Filed: Jun. 7, 2006

(51) Int. Cl. B25B 1/20

(52) U.S. Cl. 269/41

(57) ABSTRACT

A compact corner clamp includes first and second clamping surfaces which extend transversely to one another; a first clamping member having third and fourth clamping surfaces with the first and third clamping surfaces facing one another to clamp therebetween a first workpiece and the second and fourth clamping surfaces facing one another to clamp therebetween a second workpiece which extends transversely to the first workpiece; and an adjustable member which is movable toward and away from the first and second clamping surfaces and securable in a selected adjustment position. The first clamping member is slidably mounted on the adjustable member for moving toward the first and second clamping surfaces when the adjustable member is secured in the selected adjustment position.

### BACKGROUND OF THE INVENTION

1. Technical Field

The present invention relates generally to clamps which are used in woodworking and the like. More particularly, the invention relates to corner clamps which are used to clamp two workpieces to form a corner joint, a T-joint or a miter joint. Specifically, the present invention relates to a compact corner clamp which includes a selectively securable adjustable member on which a clamping member is slidable via a camming engagement to move to a clamping position.

2. Background Information

There are a great number of clamps for use with woodworking and the like, including corner clamps. One of the drawbacks of many corner clamps is that they are relatively bulky and have numerous knobs and handles which extend outwardly to make them relatively awkward to work with. In addition, standard corner clamps apply a force between first and second clamping members which is perpendicular to the surfaces which the clamping surfaces engage. Thus, within the field of woodworking, there is a need for a compact clamp which provides a force other than the standard perpendicular force. In addition, there is a need for a compact corner clamp which may be quickly and easily operated.

### BRIEF SUMMARY OF THE INVENTION

The present invention provides a clamping device comprising first and second clamping surfaces which extend transversely to one another; a first clamping member having third and fourth clamping surfaces which extend transversely to one another; wherein the third clamping surface is spaced from and faces the first clamping surface whereby the first and third clamping surfaces are adapted to clamp therebetween a first workpiece; wherein the fourth clamping surface is spaced from and faces the second clamping surface whereby the second and fourth clamping surfaces are adapted to clamp therebetween a second workpiece which extends transversely to the first workpiece; an adjustable member which is movable toward and away from the first and second clamping surfaces between a plurality of adjustment positions; wherein the adjustable member is alternately rigidly securable in a selected one of the adjustment positions; wherein the first clamping member is slidably mounted on the adjustable member for moving toward the first and second clamping surfaces when the adjustable member is secured in the selected adjustment position.

The present invention further provides a clamping device comprising first and second upwardly projecting clamping surfaces which extend transversely to one another; third and fourth upwardly projecting clamping surfaces which extend transversely to one another; wherein the third clamping surface is spaced from and faces the first clamping surface whereby the first and third clamping surfaces are adapted to clamp therebetween a first workpiece; wherein the fourth clamping surface is spaced from and faces the second clamping surface whereby the second and fourth clamping surfaces are adapted to clamp therebetween a second workpiece which extends transversely to the first workpiece; wherein the third and fourth clamping surfaces are simultaneously movable downwardly and respectively laterally toward the first and second clamping surfaces via a camming surface which tapers upwardly and away from the first and second clamping surfaces.

The present invention also provides a method comprising the steps of positioning a first workpiece adjacent a first clamping surface and a second workpiece adjacent a second clamping surface which extends transversely to the first clamping surface; moving a first clamping member to a non-clamping first position in which third and fourth clamping surfaces thereof are disposed respectively closely adjacent the first and second workpieces with the first workpiece disposed between the first and third clamping surfaces and the second workpiece disposed between the second and fourth clamping surfaces; locating an adjustable member at a second position adjacent the first clamping member; securing the adjustable member at the second position; sliding the first clamping member on the adjustable member while the adjustable member is in the second position from the first position to a clamping third position in which the first and third clamping surfaces clamp the first workpiece therebetween and the second and fourth clamping surfaces clamp the second workpiece therebetween.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a perspective view of the corner clamp of the present invention attached to a fixture or supporting structure.

FIG. 2 is an exploded perspective view of the corner clamp and the supporting structure.

FIG. 3 is a bottom plan view of the corner clamp.

FIG. 4 is a top plan view of the corner clamp with first and second workpieces disposed therein prior to the clamping thereof.

FIG. 5 is a sectional view taken on line 5-5 of FIG. 4.

FIG. 6 is a sectional view taken on line 6-6 of FIG. 4.

FIG. 7 is a view similar to FIG. 4 showing the corner clamp having been adjusted to a position with the wedge member engaging the workpieces prior to applying the clamping force.

FIG. 8 is a sectional view taken on line 8-8 of FIG. 7 and shows the tightening of the set screw to secure the adjustable member.

FIG. 9 is similar to FIG. 8 and shows the actuating screw being rotated to force the wedge member downwardly and toward the opposed clamping surfaces to likewise apply force to the workpieces in the same directions.

FIG. 10 is a top plan view of the box clamp shown clamping two workpieces in a T-joint configuration.

FIG. 11 is a top plan view of the corner clamp showing the lateral movement of the wedge member in order to accommodate two workpieces having different thicknesses.

FIG. 12 is a perspective view of the corner clamp using an alternate embodiment of the actuating member.

FIG. 13 is an exploded perspective view of the corner clamp showing the alternate embodiment of the actuating member.

FIG. 14 is a perspective view showing the corner clamp in an inverted position showing the rotational aspect of the handle of the alternate actuating member for clamping workpieces when the corner clamp is not mounted on a supporting structure.

Similar numbers refer to similar parts throughout the drawings.

### DETAILED DESCRIPTION OF THE INVENTION

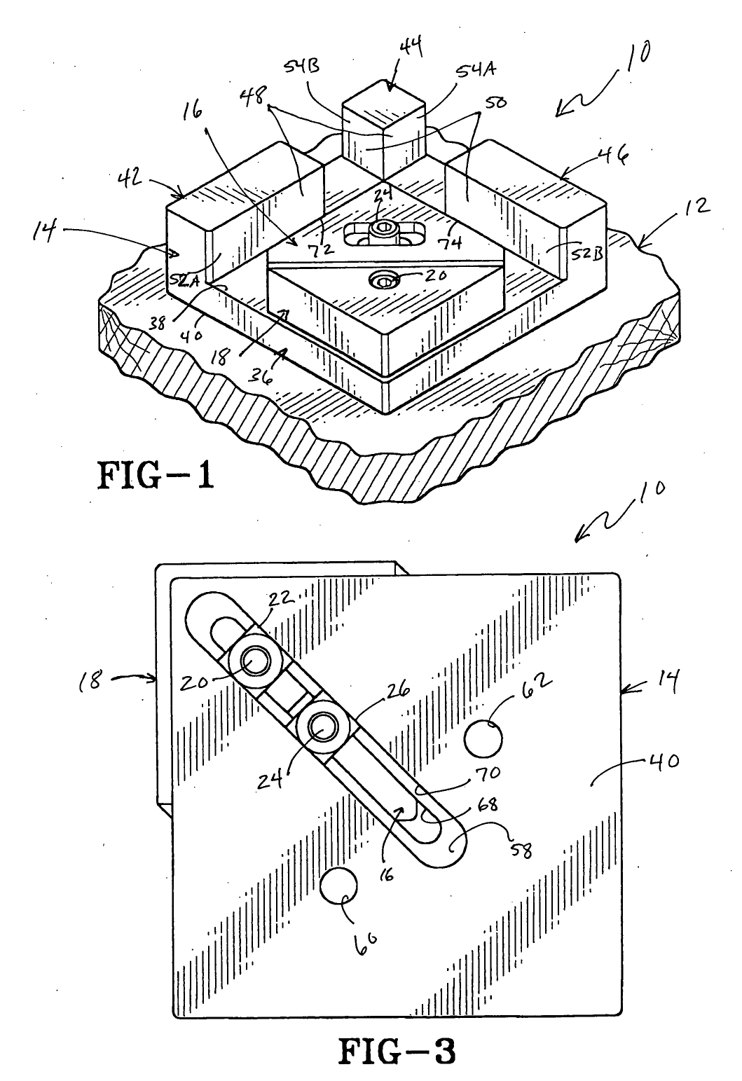

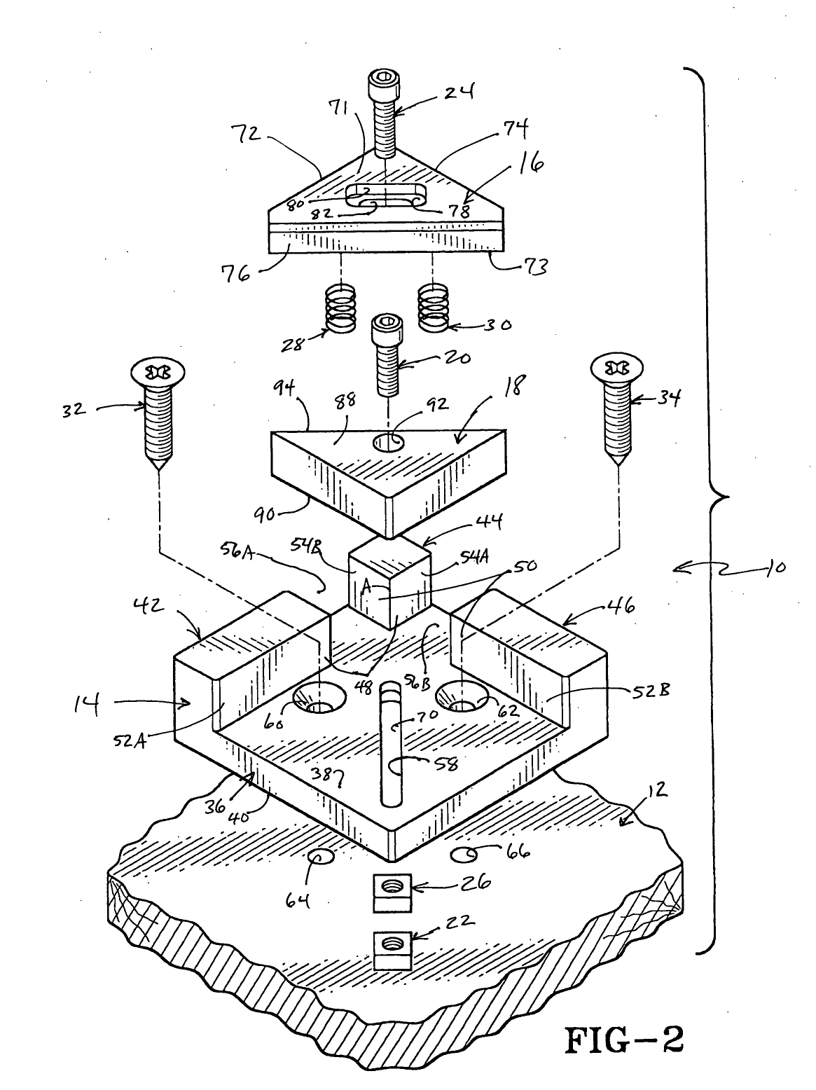

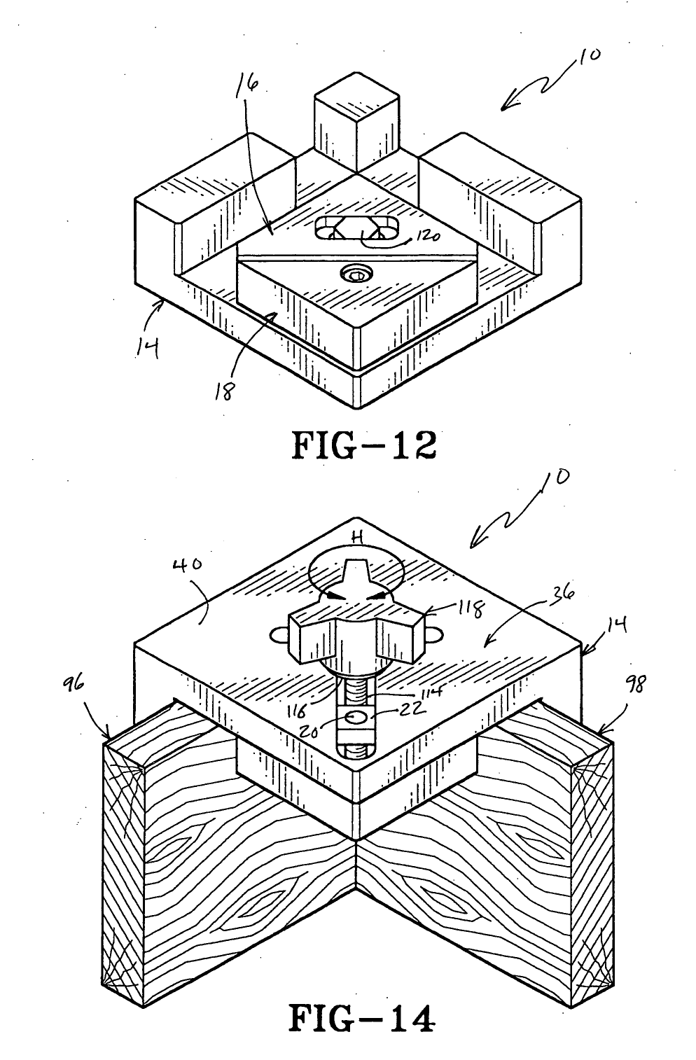

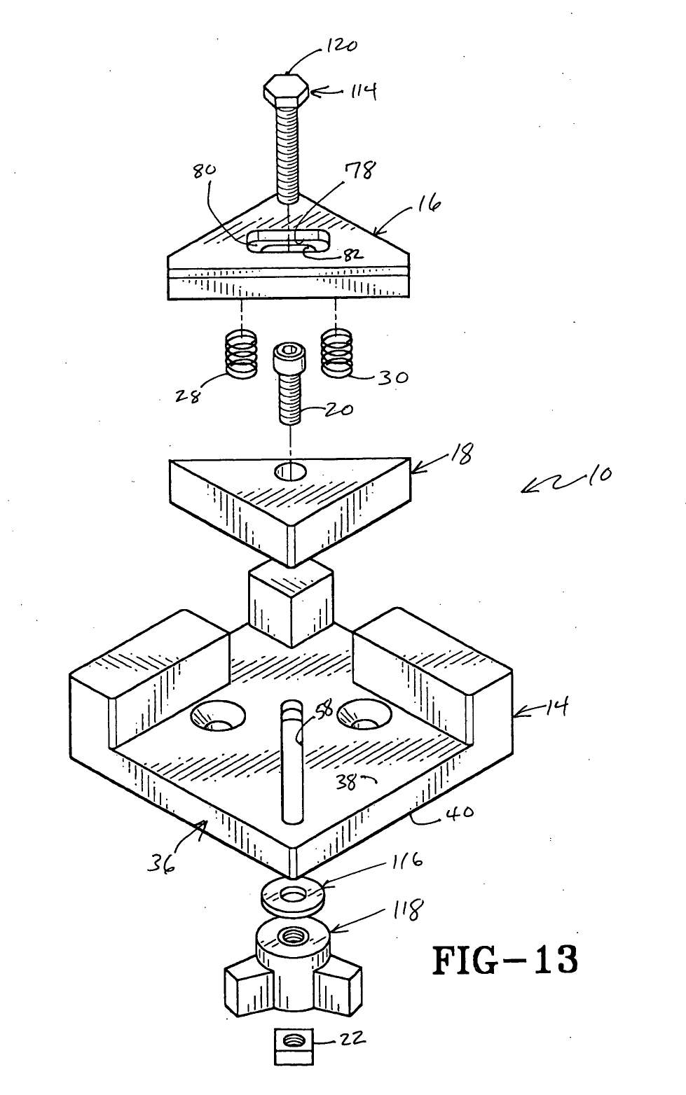

The clamp of the present invention is indicated generally at 10 in FIGS. 1 and 2. FIG. 1 shows clamp 10 mounted on a fixture or support surface 12 in a “fixture mode” although clamp 10 may be easily used in a “handheld mode” without being mounted on such a fixture, as later described with reference to FIGS. 12-14.

Referring to FIGS. 1-2, clamp 10 includes three primary members, namely a first clamping member 14, a second clamping or wedge member 16 and an adjustable member 18. Clamp 10 further includes a fastener in the form of a bolt or set screw 20 and a first nut 22 which threadedly engages set screw 20. Clamp 10 also including an actuating mechanism comprising an actuating bolt or screw 24 and a second nut 26 which threadably engages screw 24. Clamp 10 further includes first and second springs 28 and 30 for biasing wedge member 16 upwardly relative to first clamping member 14 and a pair of mounting fasteners in the form of screws 32 and 34 for securing clamp 10 to support surface 12. While clamp 10 may be disposed in any orientation, it is described herein for purposed of clarity as being mounted on a horizontal support surface 12 in order to simplify directional references. As discussed later, FIG. 14 shows clamp 10 in an inverted position in which the directional references are altered.

First clamping member 14 is now described with reference to FIGS. 1-3. Clamping member 14 includes a base in the form of a flat plate 36 which has a flat horizontal upper surface 38 and a flat horizontal lower surface 40. Member 14 further includes first, second and third clamping projections which project upwardly from base 36 from upper surface 38. First and second projections 42 and 44 include a vertical first clamping surface 48 having a first section 52A and a second section 54A respectively on projections 42 and 44. Similarly, third projection 46 and second projection 44 have a vertical second clamping surface 50 having two separated sections 52B and 54B respectively on projections 46 and 44. First projection and second projection 44 define therebetween a channel section or space 56A and second and third projections 44 and 46 likewise define therebetween a channel section or space 56B. First and second clamping surfaces 48 and 50 are perpendicular to one another relative to a vertical axis represented at A, which is the intersection or corner of second sections 54A and B of the clamping surfaces. This perpendicular arrangement is most typical although the clamping surfaces may be transverse to one another at angles other than 90° where it is desired to join two workpieces to one another at such other angles.

Base 36 defines a slot 58 which is disposed intermediate first and third projections 42 and 46 and which extends from upper surface 38 to lower surface 40 of plate 36. Slot 58 is elongated most preferably at a 45° angle with respect to each of clamping surfaces 48 and 50 and extends perpendicularly laterally away from axis A, and thus serves to bisect the angle between surfaces 48 and 50. Plate 36 further defines first and second countersunk mounting holes 60 and 62 which are disposed on opposite sides of slot 58 respectively adjacent sections 52A and 52B of the clamping surfaces. Holes 60 and 62 are configured to respectively receive mounting screws 32 and 34 for mounting first clamping member 14 to support surface 12 via holes 64 and 66 defined by support surface 12. Holes 60 and 62 are sufficiently countersunk so that the heads of screws 32 and 34 do not extend above upper surface 38 of plate 36 when clamping member 14 is secured to support surface 12. As best seen in FIG. 3, slot 58 includes an elongated counterbore which extends upwardly from lower surface 40 so that slot 58 includes a narrower portion 68 and a wider portion 70 therebelow. First and second nuts 22 and 26 are disposed in wider portion 70 of slot 58, most preferably so that no portion of either nut extends below lower surface 40 of plate 36. Likewise, it is most preferable that neither of screws 20 and 24 extend below lower surface 40 when clamp 10 is assembled so that when clamp 10 is mounted on a flat support surface 12 such as a board or the like, these screws and the corresponding nuts are able to slide within slot 58 without interference with support surface 12. Wider portion 70 of slot 58 is slightly wider than the dimensions of nuts 22 and 26 so that said nuts engage the straight surfaces of plate 36 which bound wider section 70 to prevent the rotation in order to allow screws 20 and 24 to be threaded and unthreaded therefrom without the use of a wrench or pliers to secure said nuts.

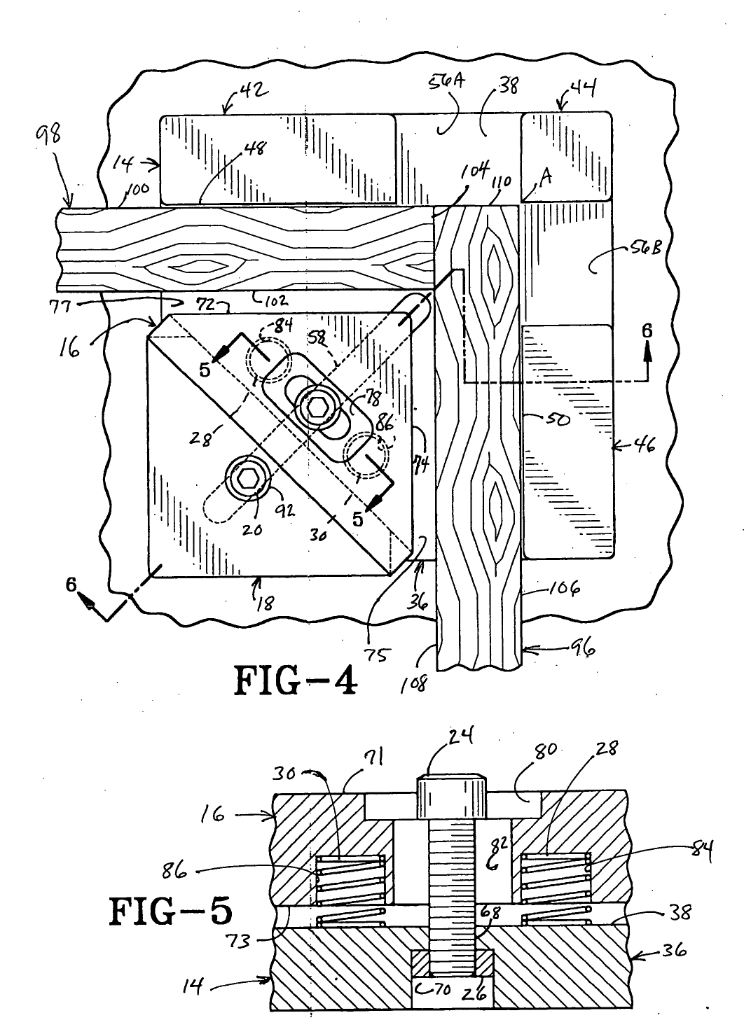

Second clamping member or wedge member 16 is a generally triangular body having upper and lower surfaces 71 and 73 and which includes third and fourth vertical clamping surfaces 72 and 74 of clamp 10. Surfaces 72 and 74 extend from upper surface 71 to lower surface 73 and are perpendicular to one another although they may be at another transverse angle as discussed with reference to first and second clamping surfaces 48 and 50. Third clamping surface 72 is spaced from and faces first clamping surface 48. Likewise, fourth clamping surface 74 is spaced from and faces second clamping surface 50. Most typically, third surface 72 will be arranged parallel to first surface 48 and fourth surface 74 will be arranged parallel to second surface 50 when clamp 10 is in a clamped position. This is in keeping with standard workpieces, which have parallel surfaces to be engaged by the clamping surfaces. When assembled, clamping surfaces 50 and 74 define therebetween a first channel 75 (FIG. 4) which is bounded therebelow by upper surface 38 of plate 36. Likewise, clamping surfaces 48 and 72 define therebetween a second channel 77 which extends perpendicularly to first channel 75 and is likewise bounded by upper surface 38.

Wedge member 16 further includes a first camming surface 76 which faces away from axis A and each of surfaces 48 and 50. More particularly, camming surface 76 tapers upwardly and away from axis A and each of surfaces 48 and 50. In the exemplary embodiment, surface 76 is a flat rectangular surface which is disposed at a 45° angle with respect to each of surfaces 48 and 50 and is perpendicular to slot 58 when wedge member 16 is in the clamped position.

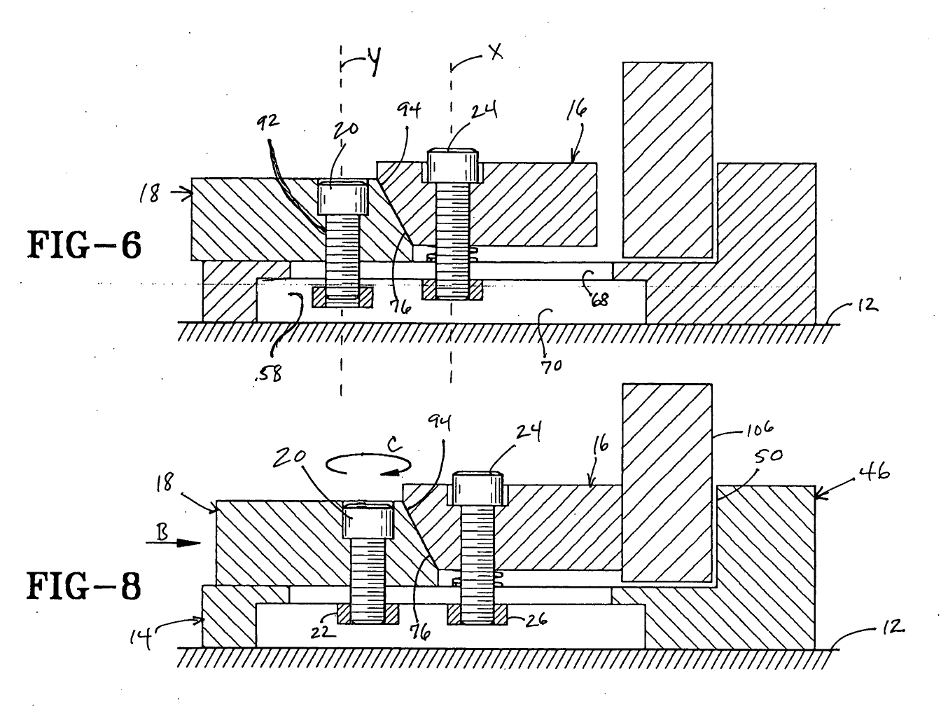

Wedge member 16 further defines a slot 78 which is elongated and parallel to camming surface 76 so that slot 78 is thus at a 45° angle to each of surfaces 48 and 50 and perpendicular to slot 58 when wedge member 16 is in the clamped position. Slot 78 receives actuating screw 24, which also extends through slot 58. It is noted that wedge member 16 is rotatable about a vertical axis X (FIG. 6) which passes through screw 24, which thus serves as a pivot so that the orientations of surfaces 72, 74 and 76 as well as slot 78 may be oriented in a limitless number of positions relative to surfaces 48 and 50. Slot 78 has an elongated counterbore so that slot 78 includes a wider portion 80 extending downwardly from upper surface 71 to a narrower portion 82 which extends downwardly therefrom to lower surface 73 of member 16. As seen in FIG. 5, the head of actuating screw 24 is disposed within wider section 80 of slot 78 and includes a tool-engageable portion which is engageable by a tool (not shown) such as a hex wrench, screwdriver or the like in order to rotate screw 24. However, the counterbore of slot 78 is not necessary for use with screw 24, but is rather used when clamp 10 is used in an inverted or other handheld position, as later discussed with reference to FIG. 14. Slot 78 allows wedge member 16 to slide laterally with respect to actuating screw 24 and first clamping member 14. This feature is particularly useful for clamping workpieces having different widths, as later discussed. While slot 78 is generally perpendicular to slot 58 and thus allows wedge member 16 to slide perpendicular to slot 58, the ability of wedge member 16 to rotate about screw 24 in combination with elongated slot 78 allows wedge member 16 to slide laterally in virtually any direction.

Wedge member 16 further defines a pair of spring receiving holes 84 and 86 (FIGS. 4-5) which are disposed adjacent slot 78 on opposite ends thereof and which extend upwardly from lower surface 73 of member 16. Springs 28 and 30 are received respectively within holes 84 and 86 and extend downwardly below lower surface 73 of wedge member 16 to engage upper surface 38 of base 36 of member 14, as seen in FIG. 5. While lower surface 73 of wedge member 16 may be forced into contact with upper surface 38 of plate 36 against the spring bias of springs 28 and 30 with a sufficient force, wedge member 16 is typically spaced upwardly of plate 36 during operation. Springs 28 and 30 slidably engage upper surface 38, which allows various sliding and rotational movements of wedge member 16 relative to plate 36. More particularly, the sliding engagement of springs 28 and 30 with upper surface 38 allows wedge members 16 to rotate about screw 24, to slide relative to screw 24 via slot 78 and to slide toward and away from axis A and clamping surfaces 48 and 50 via sliding movement of screw 24 within elongated slot 58 of plate 36.

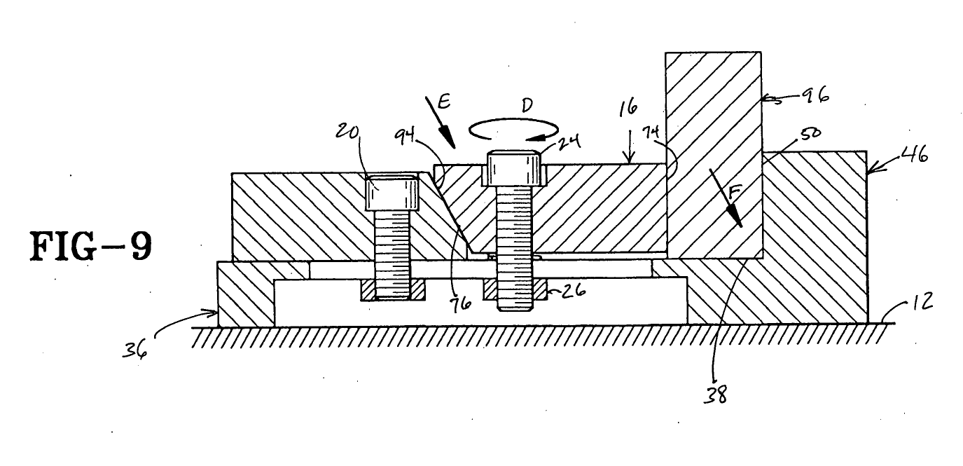

Adjustable member 18 is now described. Adjustable member 18 has upper and lower surfaces 88 and 90 and defines a hole 92 which extends from upper surface 88 to lower surface 90 for receiving therethrough set screw 20, which further extends into slot 58 to threadedly engage nut 22 within wider portion 70 of slot 58. Adjustable member 18 has a second camming surface 94 of mating configuration with first camming surface 76 of wedge member 16. More particularly, camming surface 94 faces and tapers upwardly and away from axis A and clamping surfaces 48 and 50. First camming surface 76 is configured to slidably engage second camming surface 94 so that wedge member 16 is slidable downwardly and toward axis A and clamping surfaces 48 and 50 to a clamped position (FIG. 9). In the exemplary embodiment, second camming surface 94 is a flat rectangular surface although this may vary. Lower surface 90 of adjustable member 18 is slidable along upper surface 38 of plate 36 when set screw 20 is sufficiently loosened. When set screw 20 is tightened, adjustable member 18 is rigidly connected to plate 36 so that it cannot move relative thereto. Thus, set screw 20 may be loosened so that adjustable member 18 is slidable along plate 38 with screw 20 disposed in slot 58 between a limitless number of positions at which set screw 20 may be tightened to fix the position of adjustable member 18 relative to clamping member 14. Adjustable member 18 is also rotatable about a vertical axis Y (FIG. 6) which passes through screw 20 when screw 20 is loosened.

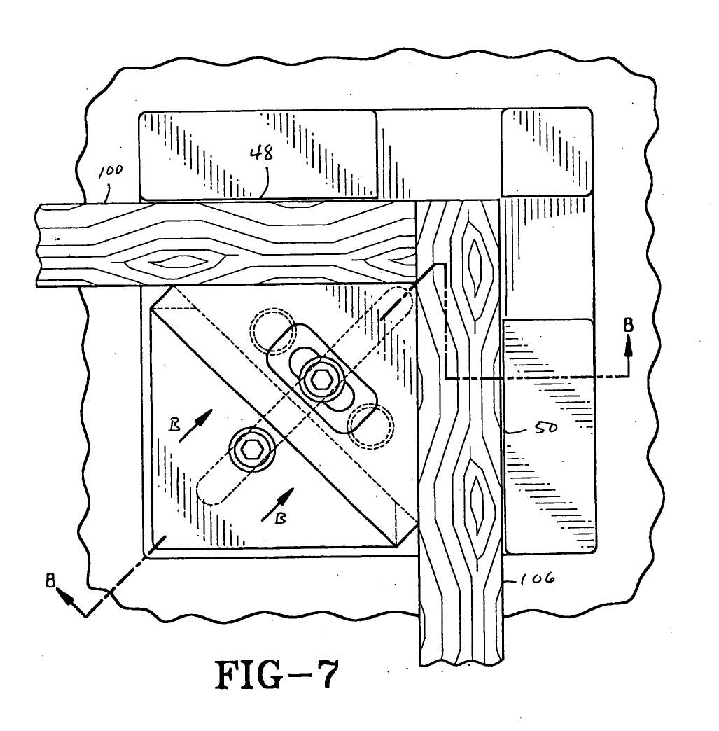

The operation of clamp 10 is now described with reference to FIGS. 4-11. As shown in FIG. 4, first and second workpieces 96 and 98 are inserted respectively in channels 75 and 77 and abut one another to form an L-shaped corner configuration. First workpiece 96 has first and second opposed flat, parallel sides 106 and 108 and an end 110. Second workpiece 98 has first and second flat, parallel opposed sides 100 and 102 and an end 104. More particularly, end 104 of workpiece 98 abuts side 108 of workpiece 96. It will be appreciated that the workpieces may be positioned in various configurations to include a mitered corner. In FIGS. 4 and 6, set screw 20 is in a loosened position so that adjustable member 18 may be slid or rotated as previously described. FIGS. 4 and 6 also show that wedge member 16 is positioned so that clamping surfaces 72 and 74 are spaced respectively from workpieces 98 and 96. While in the loosened position of set screw 20, adjustable member 18 and wedge member 16 are then moved laterally (Arrows B in FIGS. 7-8) toward axis A and first and second clamping surfaces 48 and 50 via travel of screws 20 and 24 within slot 58 of plate 36 so that third and fourth clamping surfaces 72 and 74 respectively engage workpieces 98 and 96 along sides 102 and 108. Although FIGS. 7 and 8 shows sides 100 and 106 of the workpieces spaced slightly away from clamping surfaces 48 and 50, typically sides 100 and 106 will abut surfaces 48 and 50 at this point. However, this spacing is shown to emphasize the force on and movement of the workpieces as discussed hereafter.

Once adjustable member 18 has been moved to position clamping member 16 in abutment with the workpieces, set screw 20 is tightened as indicated at Arrow C in FIG. 8 to rigidly secure adjustable member 18 to plate 36 in order to provide a rigid structure against which wedge member 16 may push in order to clamp the workpieces against first and second clamping surfaces 48 and 50. More particularly and with reference to FIG. 9, actuating screw 24 is rotated as indicated at Arrow D to force wedge member 16 downwardly whereby camming surface 76 slides along camming surface 94 to partially translate the downward force in a lateral direction toward axis A and surfaces 48 and 50 in order to clamp the workpieces between the corresponding clamping surfaces. This downward and lateral force and movement of wedge member 16 is indicated at Arrow E, whereby wedge member 16 consequently applies a force and movement in a corresponding direction to each of workpieces 96 and 98, as indicated by Arrow F in FIG. 9 with respect to workpiece 96. This force thus securely clamps the workpieces between the corresponding clamping surfaces and also forces the workpieces downwardly against upper surface 38 of plate 36.

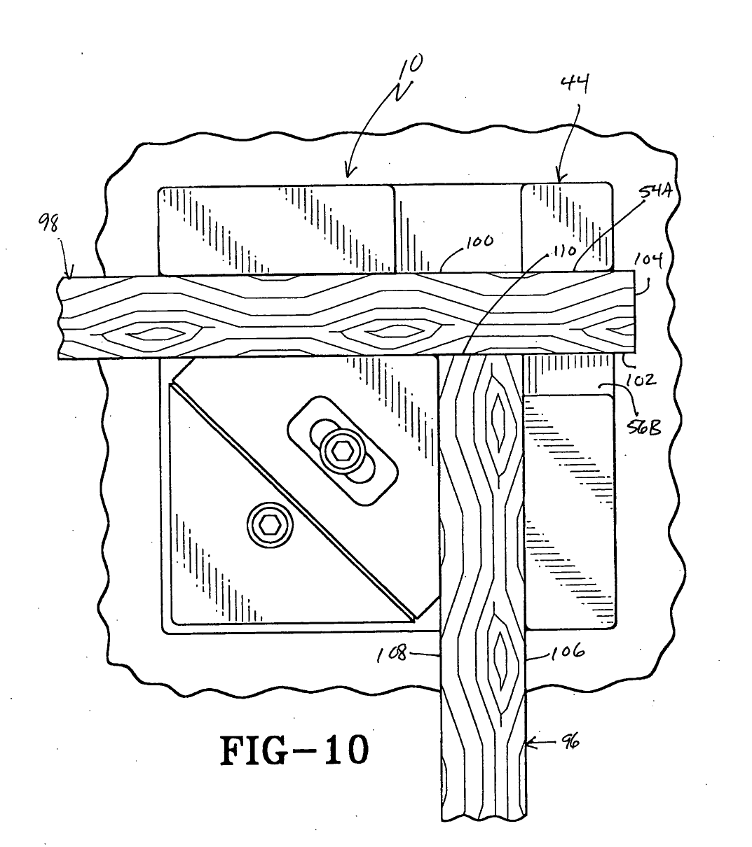

FIG. 10 shows the use of clamp 10 to clamp workpieces 96 and 98 in a T-joint configuration with end 110 of workpiece 96 abutting side 102 of workpiece 98 and end 104 of workpiece 98 extending outwardly beyond side 106 of workpiece 96. Thus, a portion of workpiece 98 adjacent end 104 thereof is disposed in channel section 56B and side 100 of workpiece 98 abuts second section 54A of first clamping surface 48. Second clamping projection 44 of clamp 10 thus provides additional backup structure for such a T-joint configuration of the workpieces to prevent workpiece 98 adjacent end 104 from bowing outwardly during clamping.

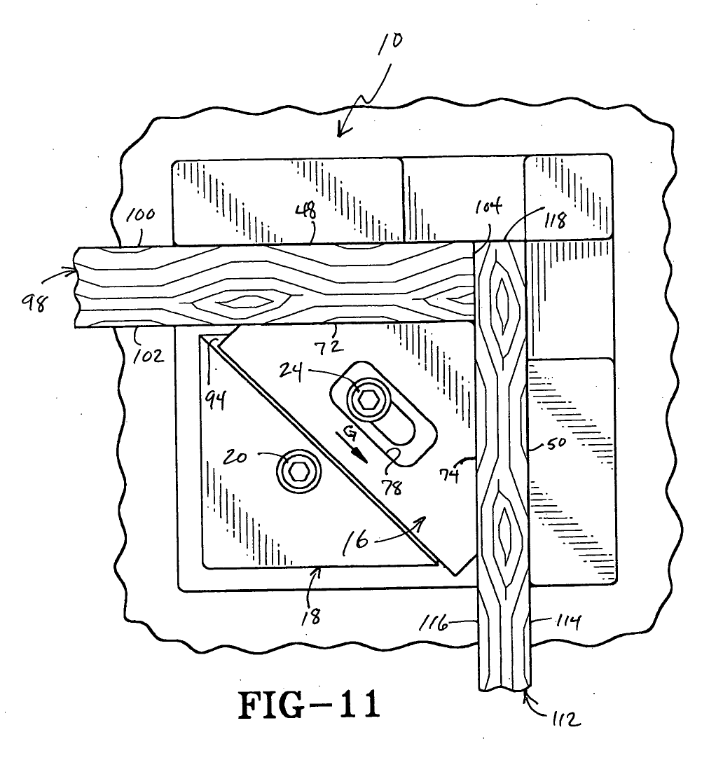

FIG. 11 illustrates the clamping of two workpieces having different thicknesses. More particularly, clamp 10 is shown clamping workpiece 98 to a workpiece 112 having sides 114 and 116 defining therebetween a thickness which is less than that of workpiece 98. Workpiece 112 has an end 118 adjacent which end 104 of workpiece 98 abuts side 116 of workpiece 112. FIG. 11 thus illustrates the particular usefulness of slot 78 in allowing wedge member 16 to slide along screw 24 as indicate at Arrow G in order to allow wedge member 16 to move to a position suited to clamp the thicker and thinner workpieces 98 and 112. This movement of wedge member 16 thus allows for the decreasing of the perpendicular distance between clamping surfaces 74 and 50 while simultaneously allowing for the increase of the perpendicular distance between clamping surfaces 72 and 48, or vice versa. This sliding movement may be achieved while the camming surfaces of wedge member 16 and adjustable member 18 are in contact and thus the camming surfaces are slidable in the direction indicated at Arrow G and in the opposite direction as well. This sliding movement of wedge member 16 may be achieved while set screw 20 is tightened or when it is loosened. In addition, it is noted that members 16 and 18 are independently moveable and may be separated from one another while still connected to plate 16 although the figures do not indicate this. Thus, the elongated slots in plate 36 and wedge member 16 allow for the various sliding movement previously discussed as well as rotational movement of members 16 and 18 so that in combination, members 16 and 18 may be moved with a relatively great deal of complexity, thus allowing wedge member 16 to accommodate workpieces of various thicknesses as noted with reference to FIG. 11 as well as workpieces which have sides which are not necessarily parallel to one another.

The alternate embodiment of the actuating mechanism is now described with reference to FIGS. 12-14. All aspects of clamp 10 remain the same except for the alternate actuating mechanism, which replaces actuating screw 24 and nut 26 of the earlier described actuating mechanism. The alternate actuating mechanism includes a threaded screw or bolt 114, an optional washer 116 and a manually operable knob-like handle 118 which is internally threaded to threadably engage the threaded portion of bolt 114. Bolt 114 includes a hexagonal head 120 having flats which engage flat portions of wedge member 16 within wider section 80 of slots 78 to prevent rotation thereof when head 120 is disposed in slot 78. The threaded portion of bolt 114 extends through narrow section 82 of slot 78, through slot 58 of plate 36 and extends below lower surface 48 of plate 36 through the opening in washer 116 and into the threaded hole of handle 118, a portion of which thus serves as a nut. Washer 116 when used abuts lower surface 40 of plate 36. In FIG. 14, clamp 110 is shown in an inverted position so that lower surface 40 of plate 36 becomes an upper surface or upwardly facing surface of plate 36. This outward extension of handle 118 and washer 116 from surface 40 is in contrast to that of the first actuating mechanism which included screw 24 and nut 26, in which no portion of the clamp extended below lower surface 40 of plate 36 except for the mounting screws 32 and 34. In the alternate embodiment of the actuating mechanism, handle 118 extends outwardly from surface 40 and is conveniently manually rotated as indicated at Arrow H in FIG. 14 in order to tighten or loosen the actuating mechanism and accordingly to either provide the force which moves wedge member 16 toward plate 36 or allow it to move away from plate 36. This alternate configuration of the actuating mechanism thus provides for a clamp which is easily maneuvered and operated by hand in various orientations. For instance, one clamp 10 using the first actuating mechanism may be mounted on support surface 12 in order to clamp two workpieces while another clamp 10 using the alternate actuating mechanism may be clamped to the same two workpieces at the other end thereof whereby handle 118 provides easy access to provide the actuating movement required for the latter clamp 10. It will be appreciated by one skilled in the art that handle 118 is easily accessed when it extends outwardly from surface 40 of plate 36 whereas a similar type of handle would not be easily manipulated if positioned so that it extended outwardly from upper surface 71 of wedge member 16 due to the limited space available once the workpieces are inserted in clamp 10 prior to the clamping thereof.

Thus, clamp 10 provides a compact handheld clamp which is thus easily maneuverable in any orientation for clamping workpieces as described herein. Clamp 10 may thus be configured to mount on a fixture or supporting surface or may be maneuvered freely by hand to clamp to a pair of workpieces to form a corner joint, a T-joint, a miter joint or the like whether the workpieces are of the same thickness or different thicknesses. In the preferred embodiment of clamp 10, base 36 is substantially square and has sides having a length of only about four inches. While the concept of the invention is certainly not limited to such dimension, it is clear that a clamp of such a size is very convenient for use in a variety of situations. While the clamp may be formed in a variety of ways, the clamping members and preferably the adjustable member are machined from a metal in order to provide highly accurate surfaces which are suitable for high end woodwork or work with other types of materials.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A clamping device comprising:
first and second clamping surfaces which extend transversely to one another;
a first clamping member having third and fourth clamping surfaces which extend transversely to one another;
wherein the third clamping surface is spaced from and faces the first clamping surface whereby the first and third clamping surfaces are adapted to clamp therebetween a first workpiece;
wherein the fourth clamping surface is spaced from and faces the second clamping surface whereby the second and fourth clamping surfaces are adapted to clamp therebetween a second workpiece which extends transversely to the first workpiece;
an adjustable member which is movable toward and away from the first and second clamping surfaces between a plurality of adjustment positions;
wherein the adjustable member is alternately rigidly securable in a selected one of the adjustment positions;
wherein the first clamping member is slidably mounted on the adjustable member for moving toward the first and second clamping surfaces when the adjustable member is secured in the selected adjustment position.

2. The device of claim 1 wherein the first, second, third and fourth clamping surfaces project upwardly; and wherein the third and fourth clamping surfaces are simultaneously movable downwardly and respectively laterally toward the first and second clamping surfaces via a first camming surface which tapers upwardly and away from the first and second clamping surfaces.

3. The device of claim 2 wherein the first clamping member includes the first camming surface; wherein the adjustable member includes a second camming surface which tapers upwardly and away from the first and second clamping surfaces; and wherein the first and second camming surfaces slidably engage one another.

4. The device of claim 2 further including a threaded actuating member which is rotatable to move downwardly; and wherein the third and fourth clamping surfaces are movable via the first camming surface in response to downward movement of the actuating member.

5. The device of claim 1 further including a base; wherein one of the base and the first clamping member defines a first elongated slot; and further including a first fastener which extends from the other of the base and the first clamping member into the first slot for fastening the first clamping member to the base.

6. The device of claim 5 wherein the base defines the first slot; wherein the first slot has a first elongated direction; wherein the first fastener is slidable within the first slot in the first elongated direction; wherein the first clamping member defines a second elongated slot which is elongated in a second direction transverse to the first elongated direction; and wherein the first fastener is disposed in the second slot so that the first clamping member is slidable with respect to the first fastener in the second direction.

7. The device of claim 5 wherein the first clamping member defines the first slot so that the first clamping member is slidable with respect to the first fastener.

8. The device of claim 5 wherein the first fastener includes a nut and a bolt having a head and a threaded portion which threadedly engages the nut; wherein one of the nut and the head is disposed in the first slot; and wherein the one of the base and the first clamping member engages the one of the nut and the head to prevent rotation thereof.

9. The device of claim 1 wherein the first clamping member is pivotable about a first axis; and wherein the adjustable member is pivotable about a second axis which is parallel to and offset from the first axis.

10. The device of claim 9 further including a first fastener through which the first axis passes, a second fastener through which the second axis passes and a base defining at least one opening; wherein the first clamping member defines an opening in which the first fastener is disposed; wherein the adjustable member defines an opening in which the second fastener is disposed; and wherein each of the fasteners is disposed in one of the at least one opening of the base.

11. The device of claim 1 further including a base having an upwardly-facing surface and a downwardly-facing surface adapted to contact a supporting surface when the base is mounted thereon; wherein the upwardly-facing surface is adapted to contact the first and second workpieces when clamped in the clamping device; wherein the first, second, third and fourth clamping surfaces project upwardly above the upwardly-facing surface of the base; further including an actuating member; wherein the first clamping member is movable toward the first and second clamping surfaces via a camming engagement with the adjustable member in response to movement of the actuating member; and wherein no portion of the actuating member extends below the downwardly-facing surface of the base during operation of the clamping device.

12. The device of claim 11 further including a nut; wherein the actuating member threadedly engages the nut; wherein the base defines a slot which extends from the upwardly-facing surface to the downwardly-facing surface; wherein the slot includes an elongated counterbore which extends upwardly from the downwardly-facing surface; and wherein the nut is disposed in the counterbore with no portion of the nut extending below the downwardly-facing surface of the base during operation of the clamping device.

13. The device of claim 11 further including at least one fastener which extends below the downwardly-facing surface of the base and is adapted to secure the base to the supporting surface; and wherein no portion of the device other than the at least one fastener extends below the downwardly-facing surface of the base.

14. The device of claim 1 wherein the first clamping member is slidable on the adjustable member in a first direction toward the first and second clamping surfaces; and wherein the first clamping member is slidable on the adjustable member in a second direction perpendicular to the first direction.

15. The device of claim 1 wherein the first clamping member defines an elongated slot having an elongated direction; and further including a pivot disposed in the slot; wherein the first clamping member is pivotable about the pivot and movable in the elongated direction of the slot with respect to the pivot.

16. The device of claim 1 further including a base and at least one spring which is disposed between the first clamping member and the base to bias the first clamping member away from the base; and wherein the first clamping member is slidably mounted on the base via a slidable engagement between the at least one spring and the base.

17. The device of claim 1 wherein at least one of the first and second clamping surfaces includes first and second sections which are spaced from one another to define therebetween a channel section adapted to receive a portion of one of the workpieces.

18. The device of claim 1 further including a base having first and second opposed surfaces; wherein the first surface is adapted to be contacted by the workpieces; wherein the first clamping member is disposed adjacent and outwardly of the first surface in a direction opposite of the second surface; wherein the device includes first and second actuating mechanisms which are usable in the alternate in place of one another; wherein each actuating mechanism is capable of fastening the first clamping member to the base; wherein the first clamping member is movable toward the first and second clamping surfaces via a camming engagement with the adjustable member in response to actuation of one of the actuating mechanisms; wherein the first actuating mechanism when in use includes a tool-engageable portion which is disposed adjacent the first clamping member and adapted to be engaged by a tool for actuating the first mechanism; wherein the second actuating mechanism when in use includes a manually-operable handle for actuating the second mechanism; and wherein the handle is disposed adjacent and outwardly of the second surface of the base in a direction opposite the first surface of the base.

19. A clamping device comprising:
first and second upwardly projecting clamping surfaces which extend transversely to one another;
third and fourth upwardly projecting clamping surfaces which extend transversely to one another;
wherein the third clamping surface is spaced from and faces the first clamping surface whereby the first and third clamping surfaces are adapted to clamp therebetween a first workpiece;
wherein the fourth clamping surface is spaced from and faces the second clamping surface whereby the second and fourth clamping surfaces are adapted to clamp therebetween a second workpiece which extends transversely to the first workpiece;
wherein the third and fourth clamping surfaces are simultaneously movable downwardly and respectively laterally toward the first and second clamping surfaces via a camming surface which tapers upwardly and away from the first and second clamping surfaces.

20. A method comprising the steps of:
positioning a first workpiece adjacent a first clamping surface and a second workpiece adjacent a second clamping surface which extends transversely to the first clamping surface;
moving a first clamping member to a non-clamping first position in which third and fourth clamping surfaces thereof are disposed respectively closely adjacent the first and second workpieces with the first workpiece disposed between the first and third clamping surfaces and the second workpiece disposed between the second and fourth clamping surfaces;
locating an adjustable member at a second position adjacent the first clamping member;
securing the adjustable member at the second position;
sliding the first clamping member on the adjustable member while the adjustable member is in the second position from the first position to a clamping third position in which the first and third clamping surfaces clamp the first workpiece therebetween and the second and fourth clamping surfaces clamp the second workpiece therebetween.
